(19) United States
(12) Patent Application Publication
(10) Pub. No.: US 2026/0013667 A1
(43) Pub. Date: Jan. 15, 2026

(54) Toaster-Engageable Toasting Basket

(71) Applicant: James Warner Haskins, San Diego, CA (US)

(72) Inventor: James Warner Haskins, San Diego, CA (US)

(21) Appl. No.: 19/050,388

(22) Filed: Feb. 11, 2025

Related U.S. Application Data
(60) Provisional application No. 63/668,924, filed on Jul. 9, 2024.

(51) Int. Cl. A47J 37/08

(52) U.S. Cl. CPC A47J 37/0885

(57) ABSTRACT

A toaster-engageable toasting basket is provided which is adapted for operative positioning within a toaster slot. The basket is configured to hold pieces of food in a compressed engagement between basket sidewalls in fixed positions. This holds the food pieces in place for toasting within the toaster slot.

This application claims priority to U.S. Provisional Patent Application Ser. No. 63/688,924 filed on Jul. 9, 2024.

### FIELD OF THE INVENTION

The present device relates generally to toasting components for the home and office. More particularly, the disclosed device and system relate to a toasting basket configured for holding small edible precooked foodstuffs therein in a substantially fixed position, while the basket is operatively engaged with a toaster or similar counter top toasting device.

### BACKGROUND OF THE INVENTION

Electric toasters are widely employed toasting devices throughout the world. The basic concept of the majority of such conventional toasters is a simple one. Such toasters employ electric current supplied to the toaster, which is communicated to elongated conductors which use the electric current to generate infrared radiation within heating cavities, in which the conductors are located.

With a design of such toasters primarily adapted for the insertion of bread into one or more of the toaster toasting slots, it is not a surprise that conventional toasters are primarily employed for toasting either sliced bread or other baked goods and the like, all of which having a similar thickness and overall size similar to a slice of bread.

In operation, users of conventional toasters will insert the lower half of a slice of uncooked bread into a toasting slot until it contacts against a moveable support rack. Thereafter, the user will push a toaster control lever downward to move the bread and support rack lower to a toasting position. The bread remains in the lowered position until the inserted bread has reached a predetermined level of warming or toasting. These conventional toaster appliances work well when used for the designed purpose of warming or toasting foodstuffs substantially the overall size of a piece of sliced bread.

The forgoing background concerning conventional toaster appliances and limitations related therewith are intended to be illustrative and not exclusive, and they do not imply any limitations on the toaster engageable toasting basket invention described and claimed herein. Various other limitations of the related art of conventional bread toasters are known or will become apparent to those skilled in the art upon a reading and understanding of the specification below and the accompanying drawings.

It is an object of this invention to provide a toasting basket sized to hold precooked foods therein, where the toasting basket is configured for operative positioning into the toasting slot of a conventional toaster with the handle or handles extending therefrom outside the toaster.

It is an additional object of this invention to provide such a toaster slot engageable toasting basket which is adapted to hold small foodstuffs in fixed positions within the basket, while the basket is engaged within a toaster slot, to thereby allow for toasting of precooked food by the toaster which is significantly smaller than a bread slice.

It is a further object of this invention to provide such a toasting basket wherein one mesh sidewall is in a hinged connection to a drip tray to allow for easy cleaning of food caught in the drip tray during prior use.

These and other objects, features, and advantages of the present toasting basket which is configured for operative positioning within a toaster slot, as well as the advantages thereof over existing prior art which will become apparent from the description to follow, are accomplished by the basket device and system described in this specification and hereinafter described in the following detailed description which fully discloses the invention, but should not be considered as placing limitations thereon.

### SUMMARY OF THE INVENTION

The disclosed toasting basket invention herein provides for a significant increase in the overall utility of conventional toasters which heretofore are primarily employed to toast bread slices and other sliced bread products.

The device and system herein includes a toasting basket which has opposing sidewalls which are formed of metal mesh using stiff metal members with gaps therebetween. This construction provides a toasting basket structure which is rigid and holds it shape as well as having large openings in between the metal members. These large opening areas allow infrared heat from the heating elements on the opposing sides of a toaster slot to communicate therethrough to toast the food held in the basket.

It is highly preferred that the formed openings in the formed metal mesh have a rectangular shape where a longest side of the rectangle are in a range from 1.5-1.75 inches and the smaller sides of the rectangle are in a range from 0.33-0.5 inches. By maintaining the openings with no side longer than 1.75 inches and a height or a short side of no more than 0.5 inches, the sidewalls of the formed toasting basket are well adapted to hold small frozen snacks and precooked foodstuffs like “nuggets” fixed in place during the heating and toasting process. This sizing of the openings and a hinged sidewall allow the user to easily form a stack of such small foodstuffs into the basket by placing them on one mesh sidewall in the desired grouping. Once the hinged mesh sidewall is rotated to a closed position, spaced from the fixed mesh sidewall, contact of the two mesh sidewalls against the inserted foodstuff will hold the food pieces in a fixed position for the duration of the toasting process.

The toasting basket includes a first metal mesh sidewall which is in a fixed positioning to a top edge of the drip pan where it extends above the first sidewall of the drip pan. The drip pan in all modes of the device herein is positioned to be at the lower end of the toasting basket. A second metal mesh sidewall is in a hinged or pivoting engagement with a second sidewall of the drip pan.

The drip pan is solid-walled and being positioned at the lower end of the formed toasting basket. This locates the drip pan in position to catch crumbs, liquid drips, and other food material which may dismount from the food being held stationary in the toasting basket during toasting in a toaster slot.

On opposing ends of the drip pan are positioned secondary walls of the drip pan. Two opposing endwalls which are sized to fill up the gap between the mesh sidewalls. These endwalls may be formed of a solid metal or other heat resistant material or they may be formed in a mesh configuration similar to that of the opposing metal mesh sidewalls. This mesh configuration may be preferable to allow for movement of heat and heated air within the toasting slot and toasting area during the toasting process. However, a solid end wall on opposing ends of the drip pan may also be used and may provide a means to maintain the heated air within the toasting basket.

As noted, one of the mesh sidewalls is rotationally engaged to one of the elongated sidewalls of the drip pan. The fixed mesh sidewall is engaged to the opposing elongated sidewall of the drip pan. In use, loading and unloading smaller foodstuffs to fixed positions within the toasting basket, the fixed sidewall may be positioned upon a counter or support surface. Once so positioned, the second mesh sidewall may be rotated in a direction away from the first or fixed sidewall. Rotating the second mesh sidewall away from the first mesh sidewall will expose a toasting area positioned between the fixed first mesh sidewall and the opposing endwalls engaged to opposite ends of the drip pan. Alternatively, the opposing endwalls may be engaged to opposing ends of the first or fixed mesh sidewall.

This configuration, where the opposing endwalls project above the first or fixed mesh sidewall, is preferred in that it provides the user a fixed size designated toasting area into which the user may fit the precooked foodstuffs they wish to toast. Once so positioned, rotating the second mesh sidewall which is in a hinged engagement to the drip pan, back to a closed position, will cause a contact of both the first mesh sidewall and second mesh sidewall against opposite sides of the foodstuffs located in the toasting area. This opposing contact of both metal mesh sidewalls with the food, will provide a compression contact therewith to hold each piece of food in a respective position while the toasting basket is inserted into a toaster slot, and while the food is toasting within the toaster slot.

Extending from top or side edges of at least the first mesh sidewall and, preferably, both the first mesh sidewall and second mesh sidewall are handle arms. Each of the handle arms may have a handle positioned at a distal end thereof. The handle arms extending from engagements with each mesh sidewall locate the grip handles in a spaced positioning from one side edge of the mesh toasting basket. This provides for an easy grip by the user of the grip handles while they guide the toasting basket into and out of a toaster slot.

With regard to the above description, before explaining at least one preferred embodiment of the toasting basket herein, in detail, it is to be understood that the toaster-engageable toasting basket invention is not limited in its application to the details of construction and/or to the arrangement or to the steps in the system in the following description or illustrated in the drawings. The toaster-engageable toasting basket herein described is capable of other embodiments and of being practiced and carried out in various ways which will become obvious to those skilled in the art upon the reading of this disclosure. Also, it is to be understood that the phraseology and terminology employed herein are for the purpose of description and should not be regarded as limiting.

As such, those skilled in the art will appreciate that the concept upon which this disclosure is based, may readily be utilized as a basis for constructing other equivalent toaster-engageable toasting baskets. It is important, therefore, that the claims herein be regarded as including such equivalent construction and methodology of toaster-engageable toasting baskets insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially”, unless otherwise specifically defined, means plus or minus five percent.

The noted and other objects, features, and advantages of the disclosed toaster-engageable toasting basket as disclosed herein, as well as the advantages thereof over existing prior art, will become apparent from the description to follow. Such are accomplished by the improvements described in this specification and hereinafter described in the following detailed description which fully discloses the system herein, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed toaster-engageable toasting basket for toasting smaller precooked foodstuffs. It is intended that the embodiments and figures disclosed herein are to be considered illustrative of the invention herein, rather than limiting in any fashion.

In the drawings:

FIG. 1 depicts a toaster-engageable toasting basket device in an open position having a defined toasting area between the first mesh sidewalls and two endwalls extending from engagements to the first sidewall or from ends of the drip basket.

FIG. 1A shows the toasting basket device herein wherein the second mesh sidewall has been rotated in its pivoting connection to a sidewall of the drip

FIG. 2 shows the device, as in FIG. 1 wherein the second mesh sidewall is being rotated on the hinged engagement to the drip basket to a vertical position, as it is moved to the configuration shown in FIG. 3.

FIG. 3 shows the device herein, wherein the second mesh sidewall has been rotated to a closed position adjacent and spaced from the first mesh sidewall, whereby compression imparted by the first mesh sidewall and second mesh sidewall hold the food pieces in the toasting area in place.

FIG. 4 depicts, in simple format, a drawing of the disclosed food toasting basket herein viewed from the side on which the second mesh sidewall is rotationally engaged to one sidewall of the drip pan and wherein the endwalls are formed of metal mesh and extend from engagements to the first sidewall.

FIG. 5 depicts the operative engagement of a plurality of toasting baskets herein, wherein the toasting area and food pieces therein are operatively positioned within conventional slots of a conventional toaster for cooking.

### DETAILED DESCRIPTION OF THE INVENTION

In this description, the directional prepositions of up, upwardly, down, downwardly, front, back, top, upper, bottom, lower, left, right, first, second, and other such terms refer to the toaster-engageable toasting basket device as it is oriented and appears in the drawings and all such terms are used for convenience only and such are not intended to be limiting or to imply that the toasting basket device has to be used or positioned in any particular orientation.

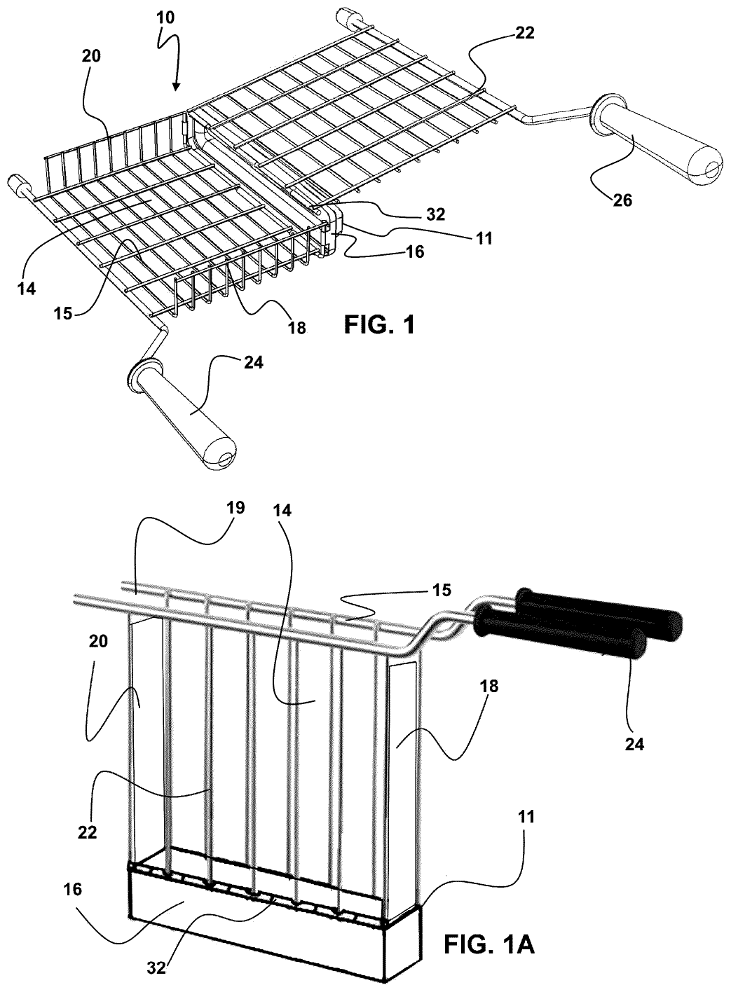

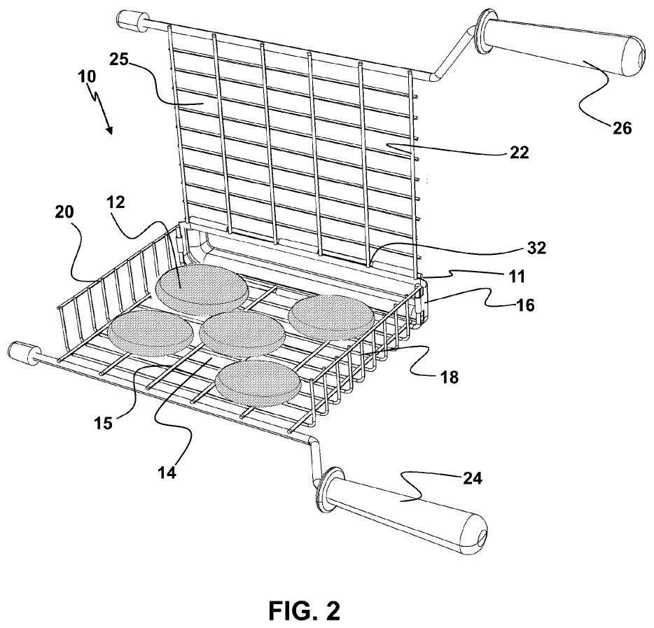

Now referring to drawings in FIGS. 1-5, there is seen in FIG. 1 the body 11 of a toaster engageable toasting basket device 10. As shown, the body 11 of the toasting basket device 10 is positioned in the open position wherein small pieces of food 12 such as in FIG. 2 may be positioned and removed from the toasting area 14.

The toasting area 14 is defined by the gap area between a first sidewall 15 and a second sidewall 22 and a basket bottom formed by a drip tray 16 to which the first sidewall 15 and second sidewall 22 are engaged, when the first sidewall 15 and second sidewall 22 extend from the drip tray 16 substantially parallel to each other. By substantially parallel is meant that the first sidewall 15 and second sidewall 22 are within ten degrees of being parallel. By drip tray 16 is meant herein, that the basket bottom has an upper surface which is solid and will catch drips and crumbs from food thereon.

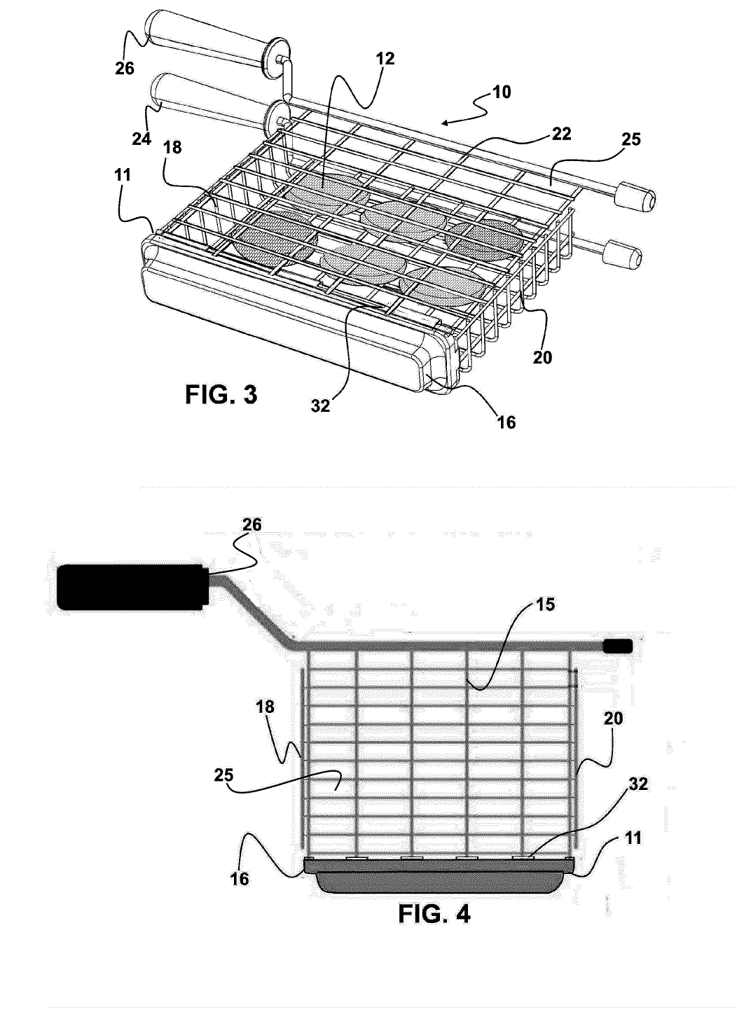

As noted, the basket device 10 may include a first endwall 18 and second endwall 20 which are in fixed positions. They may be in a fixed engagement to the first sidewall 15 as in FIG. 1-2, or they may extend from fixed engagements to opposing ends of the drip tray 16 as in FIG. 1A and FIG. 3.

The fixed positioning of the first endwall 18 and second endwall 20 which both run in a direction substantially perpendicular to the first sidewall 15, forms a toasting area 14 therebetween. The toasting area 14 so formed, has a height or depth substantially equal to the extension distance of the first endwall 18 and second endwall 20 above the surface of the first sidewall 15 which defines a gap between the first sidewall 15 and second sidewall 22. Currently, a favored dimension for the gap 19 between the first sidewall 15 and second sidewall 22 with the basket device 10, such as in the closed position of FIG. 1A and FIG. 3, is substantially one inch or less. This one inch or less gap 19 has shown in experimentation to hold a plurality of small pieces of food 12 fixed in place within the toasting basket once the second sidewall 22 has been rotated to the closed position as shown in FIG. 3, and compression is imparted to both sides of the food 12 by the two sidewalls. However, the gap 19 may be adjusted where larger pieces of food or the like are desired for positioning within the toasting area 14 and the toaster slot for engagement of the basket device 10 is extra wide such as for bagels and the like.

As noted, at least the first sidewall 15 and second sidewall 22 are preferably formed of a mesh material with large openings 25 or areas formed therein which will hold up to the temperatures within a toaster slot while the toaster heat elements are energized. Currently, metal, such as stainless steel or aluminum, may be employed, but other metals and materials suitable to the purpose may be employed.

At a distal edge of the first sidewall 15 is engaged a first handle 24, and at a distal edge of the second sidewall 22 is engaged a second handle 26. The handles 24 and 26 extend a distance from one side of the formed basket device 10 to allow the user to grip them while inserting the device 10 into and out of the slots 28 of a conventional toaster 30, as shown in FIG. 5.

During use, to toast the food 12 within a conventional toaster slot 28, the body 11 of the device 10 is moved, as shown in FIGS. 2-3, from the open position, shown in FIG. 1, to the closed or as-used position of FIG. 3. To move the device 10 to this closed position, the second sidewall 22 is in a rotational engagement, such as with a hinge 32 to one side of the drip tray 16. While not shown, it could also be rotationally engaged to either of the first endwall 18 or second endwall 20. The second sidewall 22, as shown in FIG. 2, is rotated toward the toasting area 14 with the food 12 in position during movement to the closed position of FIG. 3. In this closed position the food 12 is compressibly engaged between the first sidewall 15 and second sidewall 22.

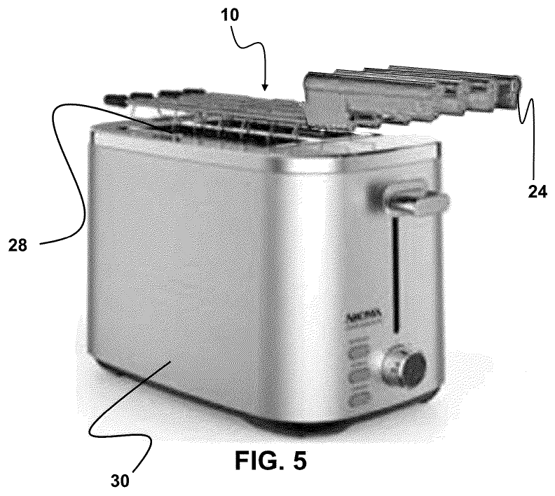

In FIG. 4 can be seen a depiction of the body 11 of the basket device in simple format. As shown, the openings 25 forming the mesh of the second sidewall 22 and the first sidewall 15 are sized with an area adapted to prevent small pieces of food 12 such as those commonly known as “nuggets” from falling through the openings 25. Further, as noted above, the depth of the toasting area 14 is defined by a gap between the first sidewall 15 and second sidewall 22 which is sized to allow compressive contact against the food 12 with the device 10 in the closed position of FIG. 3. Currently, the rectangles formed to form the mesh openings 25 have a long side with a maximum length of substantially 1.5 inches and a short side having a length of substantially 0.5 inch. However, these dimensions may vary so long as the small food 12 pieces positioned in the toasting area 14 do not slide through the mesh openings, as formed.

As noted, the device 10 herein is adapted in configuration wherein the formed toasting area 14 will fit within the confines of a slot 28 of a toaster 30. As shown in FIG. 5, while in this toasting position, the food 12 is held in place within the toasting area 14 so as to allow each piece of food 12, so held, to be exposed to the infrared heat radiating through the openings from the elements on both sides of the slot 28 on a conventional toaster 30.

While the disclosed toaster-engageable toasting basket has been described herein with reference to particular embodiments thereof and components thereof operatively engaged for operation, a latitude of equivalent modifications, various changes and substitutions are intended to be included within the foregoing disclosure and it will be appreciated that in some instance some features, or configurations, or operations of the toasting basket invention could be employed without a corresponding use of other features thereof, without departing from the scope of the invention as set forth in the following claims. All such changes, alterations and modifications as would occur to those skilled in the art subsequent to reviewing this specification, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. A toasting basket for positioning within a slot of a toaster, comprising:
a basket bottom;
a first sidewall extending from a first side of said basket bottom;
said first sidewall having first openings formed therein;
a second sidewall extending from a second side of said basket bottom;
said second sidewall having secondary openings formed therein;
a cooking area positioned between said first sidewall and said second sidewall and said basket bottom;
at least one handle extending from an engagement to either said first sidewall or said second sidewall;
said toasting basket sized for positioning within the slot of a toaster to a cooking position wherein food positioned within said cooking area is heated; and
said handle positioned outside said slot of said toaster and extending away therefrom, with said toasting basket in said cooking position.

2. The toasting basket for positioning within a slot of a toaster of claim 1, additionally comprising:
said basket bottom forming a drip tray configured for catching drips or crumbs from said food.

3. The toasting basket for positioning within a slot of a toaster of claim 1, additionally comprising:
said second sidewall in a pivoting engagement to said basket bottom;
said toasting basket having a closed position where said second sidewall is substantially parallel to said first sidewall; and
said toasting basket having an open position where said second sidewall is rotated a direction away from said first sidewall.

4. The toasting basket for positioning within a slot of a toaster of claim 2, additionally comprising:
said second sidewall in a pivoting engagement to said basket bottom;
said toasting basket having a closed position where said second sidewall is substantially parallel to said first sidewall; and
said toasting basket having an open position where said second sidewall is rotated a direction away from said first sidewall.

5. The toasting basket for positioning within a slot of a toaster of claim 3, additionally comprising:
said first sidewall in a fixed engagement with said basket bottom.

6. The toasting basket for positioning within a slot of a toaster of claim 5, additionally comprising:
said first sidewall in a fixed engagement with said basket bottom.

7. The toasting basket for positioning within a slot of a toaster of claim 1, additionally comprising:
a first endwall positioned between said first sidewall and said second sidewall;
a second endwall positioned between said first sidewall and said second sidewall in a position opposite said first sidewall; and
said first endwall and said second endwall located on opposite ends of said cooking area.

8. The toasting basket for positioning within a slot of a toaster of claim 3, additionally comprising:
a first endwall positioned between said first sidewall and said second sidewall;
a second endwall positioned between said first sidewall and said second sidewall in a position opposite said first sidewall; and
said first endwall and said second endwall located on opposite ends of said cooking area.

9. The toasting basket for positioning within a slot of a toaster of claim 4, additionally comprising:
a first endwall positioned between said first sidewall and said second sidewall;
a second endwall positioned between said first sidewall and said second sidewall in a position opposite said first sidewall; and
said first endwall and said second endwall located on opposite ends of said cooking area.

10. The toasting basket for positioning within a slot of a toaster of claim 5, additionally comprising:
a first endwall, said first endwall in a fixed engagement with a first end of said first sidewall;
said first endwall positioned between said first sidewall and said second sidewall with said toasting basket in said closed position;
a second endwall, said second endwall in a fixed engagement with a second end of said first sidewall, opposite said first end thereof;
said second endwall positioned between said first sidewall and said second sidewall with said toasting basket in said closed position; and
said first endwall and said second endwall located on opposite ends of said cooking area with said toasting basket in said closed position.

11. The toasting basket for positioning within a slot of a toaster of claim 6, additionally comprising:
a first endwall, said first endwall in a fixed engagement with a first end of said first sidewall;
said first endwall positioned between said first sidewall and said second sidewall with said toasting basket in said closed position;
a second endwall, said second endwall in a fixed engagement with a second end of said first sidewall, opposite said first end thereof;
said second endwall positioned between said first sidewall and said second sidewall with said toasting basket in said closed position; and
said first endwall and said second endwall located on opposite ends of said cooking area with said toasting basket in said closed position.

12. The toasting basket for positioning within a slot of a toaster of claim 10, additionally comprising:
a first handle extending from an engagement with said first sidewall;
a second handle extending from an engagement with said second sidewall;
said first handle being positioned adjacent said second handle with said toasting basket in said closed position in a position for gripping thereof by one hand of a user; and
both said handle and said second handle being positioned outside said slot of said toaster and extending away therefrom, with said toasting basket in said cooking position.

13. The toasting basket for positioning within a slot of a toaster of claim 11, additionally comprising:
a first handle extending from an engagement with said first sidewall;
a second handle extending from an engagement with said second sidewall;
said first handle being positioned adjacent said second handle with said toasting basket in said closed position in a position for gripping thereof by one hand of a user; and
both said handle and said second handle being positioned outside said slot of said toaster and extending away therefrom, with said toasting basket in said cooking position.
